(19) United States
(12) Patent Application Publication
(10) Pub. No.: US 2012/0262821 A1
(43) Pub. Date: Oct. 18, 2012

(54) MAGNETIC RECORDING HEAD, HEAD GIMBAL ASSEMBLY WITH THE SAME, AND DISK DRIVE

(75) Inventors: Tomoko Taguchi, Kunitachi-shi (JP); Masayuki Takagishi, Kunitachi-shi (JP); Katsuhiko Koui, Yokohama-shi (JP); Kenichiro Yamada, Tokyo (JP); Hitoshi Iwasaki, Tokyo (JP)

(73) Assignee: KABUSHIKI KAISHA TOSHIBA, Tokyo (JP)

(21) Appl. No.: 13/296,004

(22) Filed: Nov. 14, 2011

(30) Foreign Application Priority Data
Apr. 18, 2011 (JP) 2011-092344

(51) Int. Cl. G11B 5/23; G11B 17/02; G11B 5/48

(52) U.S. Cl. 360/99.08; 360/119.02; 360/244; G9B/5.06; G9B/5.147; G9B/17.002

(57) ABSTRACT

According to one embodiment, a magnetic recording head includes a main pole configured to apply a recording magnetic field perpendicular to a recording medium, a trailing-shield pole opposed to the main pole with a recording gap therebetween, a high-frequency oscillator between the main pole and the trailing-shield pole in the recording gap, configured to produce a high-frequency magnetic field, a magnetic seed layer between the main pole and the high-frequency oscillator and in contact with the main pole, and a highly oriented magnetic layer of a soft magnetic material superposed on the magnetic seed layer between the main pole and the high-frequency oscillator and in contact with the high-frequency oscillator.

### CROSS-REFERENCE TO RELATED APPLICATIONS

This application is based upon and claims the benefit of priority from prior Japanese Patent Application No. 2011-092344, filed Apr. 18, 2011, the entire contents of which are incorporated herein by reference.

### FIELD

Embodiments described herein relate generally to a magnetic recording head for perpendicular magnetic recording used in a disk drive, a head gimbal assembly provided with the same, and the disk drive.

### BACKGROUND

A disk drive, such as a magnetic disk drive, comprises a magnetic disk, spindle motor, magnetic head, and carriage assembly. The magnetic disk is disposed in a case. The spindle motor supports and rotates the disk. The magnetic head reads data from and writes data to the disk. The carriage assembly supports the head for movement relative to the disk. A head section of the magnetic head comprises a recording head for writing and a reproduction head for reading.

Magnetic heads for perpendicular magnetic recording have recently been proposed in order to increase the recording density and capacity of a magnetic disk drive or reduce its size. In one such magnetic head, a recording head comprises a main pole configured to produce a perpendicular magnetic field, return or trailing-shield pole, and coil. The return pole is located on the trailing side of the main pole with a write gap therebetween and configured to close a magnetic path that leads to a magnetic disk. The coil serves to pass magnetic flux through the main pole.

To improve the recording density, a magnetic recording head based on high-frequency magnetic field assist recording is proposed in which a spin-torque oscillator for use as a high-frequency oscillation element is disposed between main and return poles. A high-frequency magnetic field is applied from the spin-torque oscillator to a magnetic recording layer. This magnetic recording head is configured so that the distance between the respective facing surfaces of the main and return poles is reduced to enlarge a gap magnetic field.

The closer to the main pole the trailing-shield pole is located, in a conventional magnetic recording head, the higher the resolution of recording on a recording medium is. In the magnetic recording head based on high-frequency magnetic field assist recording, however, an oscillator layer and spin injection layer are disposed in a recording gap. Therefore, it is difficult to reduce the width of the recording gap, that is, the distance between the main and trailing-shield poles. If the case where the main and trailing-shield poles are located close to the spin-torque oscillator, moreover, the surrounding poles vibrate simultaneously with the oscillator. Thereupon, an energy loss increases, so that oscillation of the spin-torque oscillator is suppressed. Consequently, the intensity of a high-frequency magnetic field for the magnetization reversal of a recording layer of a perpendicular recording medium becomes insufficient, so that it is sometimes difficult to achieve sufficient recording capability.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a magnetic disk drive (HDD) according to an embodiment;

FIG. 2 is an exemplary side view showing a magnetic head and suspension of the HDD;

FIG. 3 is an exemplary enlarged sectional view showing a head section of the magnetic head;

FIG. 4 is an exemplary enlarged sectional view showing an end portion of the recording head on the side of a magnetic disk;

FIG. 5 is an exemplary perspective view schematically showing the recording head;

FIG. 6 is an exemplary deployment diagram of the recording head section taken from the ABS side of a slider;

FIG. 7 is an exemplary enlarged sectional view showing an end portion of a recording head according to a comparative example on the side of a magnetic disk;

FIG. 8 is an exemplary enlarged sectional view showing the disk-side end portion of the recording head according to the embodiment;

FIG. 9 is an exemplary diagram comparatively showing magnetic field intensity distributions corresponding to the saturated magnetic flux densities of respective magnetic layers of the recording heads according to the comparative example and the embodiment; and

FIG. 10 is an exemplary diagram showing relationships between the difference in saturated magnetic flux density, magnetic field gradient, and maximum effective magnetic field intensity.

### DETAILED DESCRIPTION

Various embodiments will be described hereinafter with reference to the accompanying drawings.

In general, according to one embodiment, a magnetic recording head comprises: a main pole configured to apply a recording magnetic field perpendicular to a recording medium; a trailing-shield pole opposed to the main pole with a recording gap therebetween; a high-frequency oscillator between the main pole and the trailing-shield pole in the recording gap, configured to produce a high-frequency magnetic field; a magnetic seed layer between the main pole and the high-frequency oscillator and in contact with the main pole; and a highly oriented magnetic layer of a soft magnetic material superposed on the magnetic seed layer between the main pole and the high-frequency oscillator and in contact with the high-frequency oscillator.

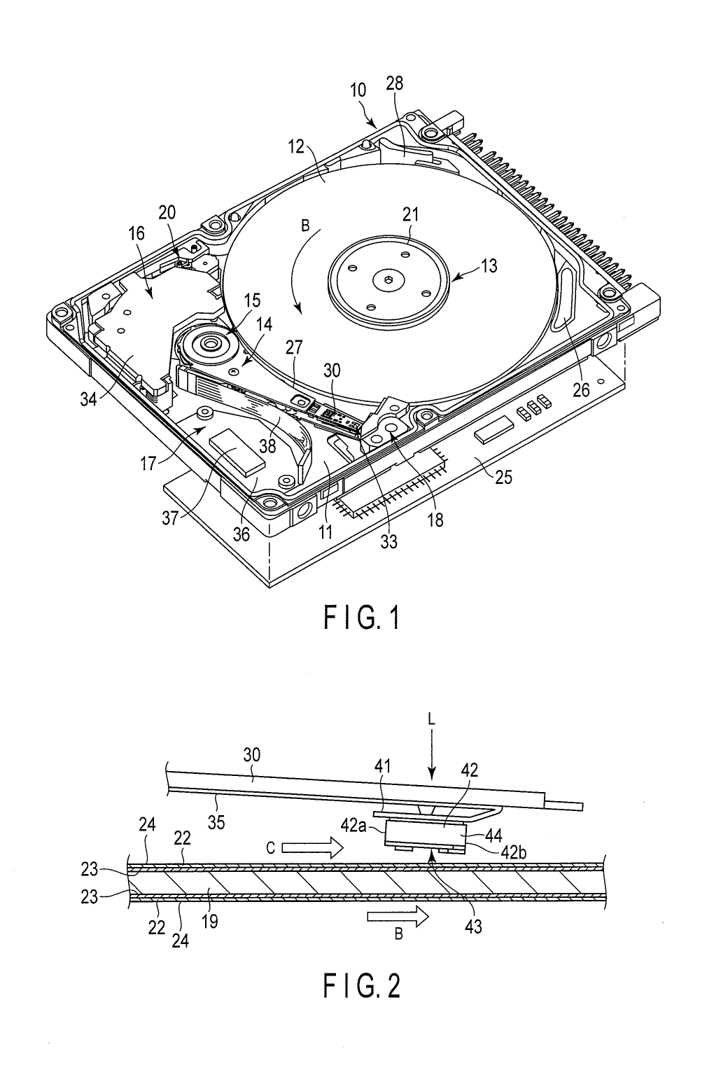

FIG. 1 shows the internal structure of a hard disk drive (HDD) as a disk drive according to an embodiment with its top cover removed, and FIG. 2 shows a flying magnetic head. As shown in FIG. 1, the HDD comprises a housing 10. The housing 10 comprises a base 11 in the form of an open-topped rectangular box and a top cover (not shown) in the form of a rectangular plate. The top cover is attached to the base by screws such that it closes the top opening of the base. Thus, the housing 10 is kept airtight inside and can communicate with the outside through a breather filter 26 only.

The base 11 accommodates a magnetic disk 12, for use as a recording medium, and a drive unit. The drive unit comprises a spindle motor 13, a plurality (e.g., two) of magnetic heads 33, head actuator 14, and voice coil motor (VCM) 16. The spindle motor 13 supports and rotates the magnetic disk 12. The magnetic heads 33 record data on and reproduce data from the disk 12. The head actuator 14 supports the heads 33 for movement relative to the surfaces of the disk 12. The VCM 16 pivots and positions the head actuator. The base 11 further accommodates a ramp loading mechanism 18, inertia latch 20, and board unit 17. The ramp loading mechanism 18 keeps the magnetic heads 33 in a position off the magnetic disk 12 when the heads are moved to the outermost periphery of the disk. The inertia latch 20 holds the head actuator 14 in a retracted position if the HDD is jolted, for example. Electronic components, such as a preamplifier, head IC, etc., are mounted on the board unit 17.

A control circuit board 25 is attached to the outer surface of the base 11 by screws such that it faces a bottom wall of the base. The circuit board 25 controls the operations of the spindle motor 13, VCM 16, and magnetic heads 33 through the board unit 17.

As shown in FIGS. 1 and 2, the magnetic disk 12 is formed as a film medium for perpendicular magnetic recording. The disk 12 comprises a substrate 19 formed of a nonmagnetic disk with a diameter of, for example, about 2.5 inches. A soft magnetic layer 23 for use as an underlayer is formed on each surface of the substrate 19. The soft magnetic layer 23 is overlain by a perpendicular magnetic recording layer 22, which has a magnetic anisotropy perpendicular to the disk surface. A protective film 24 is formed on the recording layer 22.

As shown in FIG. 1, the magnetic disk 12 is coaxially fitted on the hub of the spindle motor 13 and clamped and secured to the hub by a clamp spring 21, which is attached to the upper end of the hub by screws. The disk 12 is rotated at a predetermined speed in the direction of arrow B by the spindle motor 13 for use as a drive motor.

The head actuator 14 comprises a bearing 15 secured to the bottom wall of the base 11 and a plurality of arms 27 extending from the bearing. The arms 27 are arranged parallel to the surfaces of the magnetic disk 12 and at predetermined intervals and extend in the same direction from the bearing 15. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each magnetic head 33 is supported on an extended end of its corresponding suspension 30 by a gimbal spring 41. Each suspension 30, gimbal spring 41, and magnetic head 33 constitute a head gimbal assembly. The head actuator 14 may comprise a so-called E-block in which a sleeve of the bearing 15 and a plurality of arms are formed integrally with one another.

As shown in FIG. 2, each magnetic head 33 comprises a substantially cuboid slider 42 and read/write head section 44 on an outflow end (trailing end) of the slider. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main flexible printed circuit (FPC) board 38 (described later) through a relay FPC 35 secured to the suspension 30 and arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 11. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 15 in the direction opposite to the arms 27 and a voice coil supported on the support frame. When the head actuator 14 is assembled to the base 11, the voice coil is located between a pair of yokes 34 that are secured to the base 11. Thus, the voice coil, along with the yokes and a magnet secured to one of the yokes, constitutes the VCM 16.

If the voice coil of the VCM 16 is energized with the magnetic disk 12 rotating, the head actuator 14 pivots, whereupon each magnetic head 33 is moved to and positioned on a desired track of the disk 12. As this is done, the head 33 is moved radially relative to the disk 12 between the inner and outer peripheral edges of the disk.

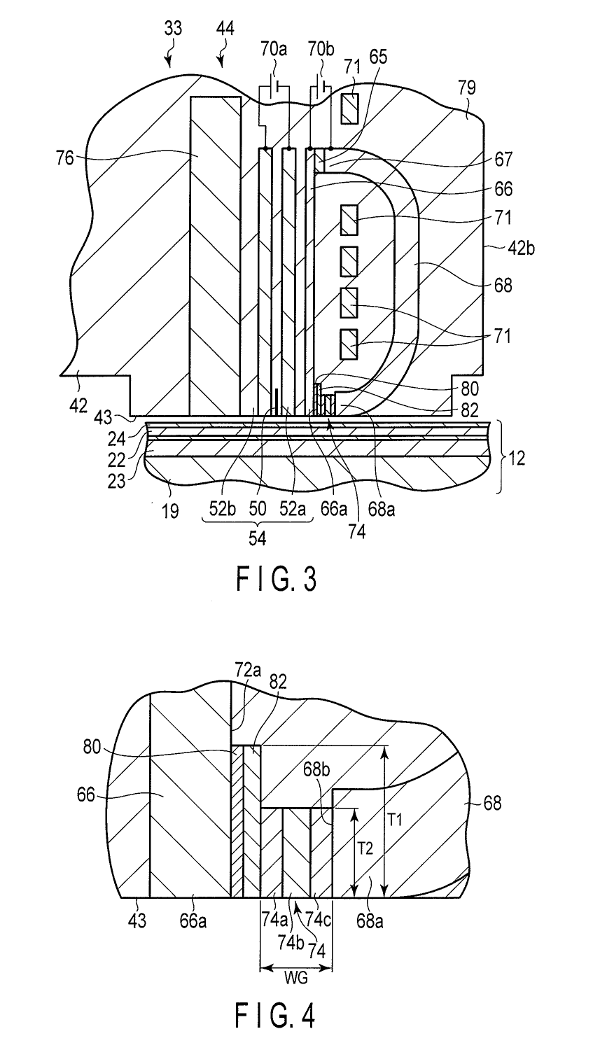

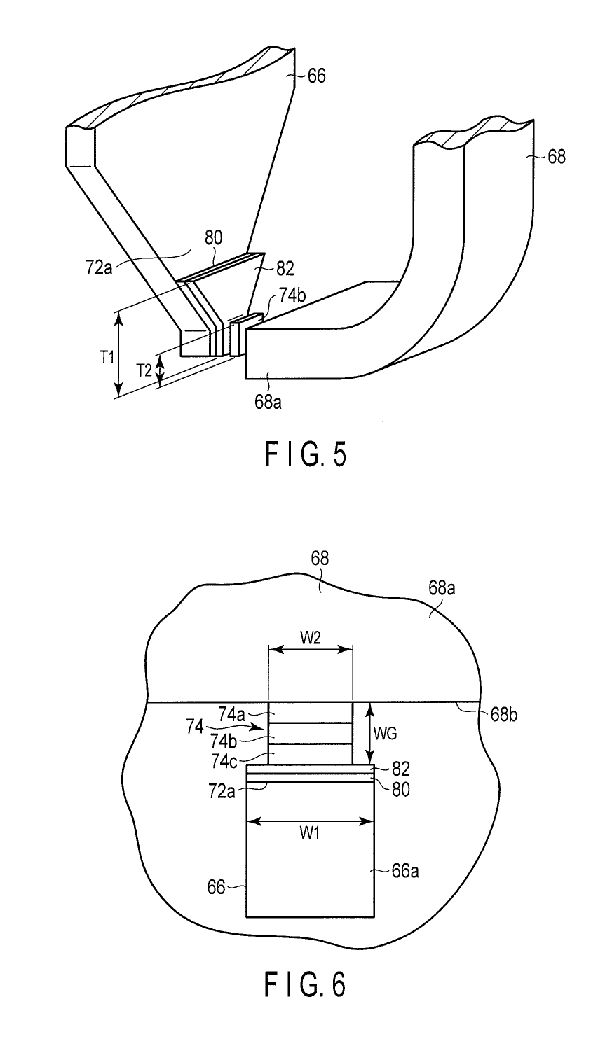

The following is a detailed description of the configuration of each magnetic head 33. FIG. 3 is an enlarged sectional view showing the head section 44 of the head 33, and FIG. 4 is an enlarged sectional view showing an end portion of a recording head on the magnetic-disk side. FIG. 5 is a perspective view schematically showing the recording head, and FIG. 6 is a deployment diagram of the recording head section taken from the ABS side of the slider.

As shown in FIGS. 2 and 3, the magnetic head (magnetic recording head) 33 is formed as a flying head, and comprises the substantially cuboid slider 42 and the head section 44 formed on the outflow or trailing end portion of the slider. The slider 42 is formed of, for example, a sintered body (AlTic) containing alumina and titanium carbide, and the head section 44 is a thin film.

The slider 42 has a rectangular disk-facing surface or air-bearing surface (ABS) 43 configured to face a surface of the magnetic disk 12. The slider 42 is kept flying at a predetermined height from the disk surface by airflow C that is produced between the disk surface and the ABS 43 as the disk 12 rotates. The direction of airflow C is coincident with the direction of rotation B of the disk 12. The slider 42 is disposed on the surface of the disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIGS. 3 and 4, the head section 44 is formed as a dual-element magnetic head, comprising a reproduction head 54 and recording head 56 formed on the trailing end 42b of the slider 42 by thin-film processing.

The reproduction head 54 comprises a magnetic film 50 having a magnetoresistive effect and shield films 52a and 52b disposed on the trailing and leading sides, respectively, of the magnetic film such that they sandwich the magnetic film between them. The respective lower ends of the magnetic film 50 and shield films 52a and 52b are exposed in the ABS 43 of the slider 42. A power supply 70a is connected to the shield films 52a and 52b.

The recording head 56 is located nearer to the trailing end 42b of the slider 42 than the reproduction head 54. The recording head 56 is constructed as a single-pole head comprising a trailing-shield pole (return pole) on the trailing end side.

The recording head 56 comprises a main pole 66, trailing-shield pole 68, and spin oscillator 74. The main pole 66 consists mainly of a soft magnetic metallic material that produces a recording magnetic field perpendicular to the surfaces of the magnetic disk 12. The trailing-shield pole 68 is disposed on the trailing side of the main pole 66 and serves to efficiently return magnetic flux through the soft magnetic layer 23 just below the main pole 66, thus forming a magnetic circuit in conjunction with the main pole. The spin oscillator 74 is arranged in recording gap WG between the main pole 66 and trailing-shield pole 68 and serves to produce a high-frequency magnetic field at a frequency of 1 GHz or more. The recording head 56 further comprises a magnetic seed layer 80, highly oriented magnetic layer 82 of a soft magnetic material, recording coil 71, and power supply 70b. The magnetic seed layer 80 is located between the main pole 66 and oscillator 74 such that it contacts the main pole. The highly oriented magnetic layer 82 is located in contact with the magnetic seed layer 80 and oscillator 74. The recording coil 71 is disposed such that it is wound around a magnetic core comprising the main and trailing-shield poles 66 and 68 to pass magnetic flux to the main pole 66 while a signal is being written to the magnetic disk 12. The power supply 70b passes direct current between the trailing-shield pole 68 and main pole 66.

As shown in FIGS. 3 to 6, the main pole 66 extends substantially perpendicular to the surfaces of the magnetic disk 12. A distal end portion 66a of the main pole 66 on the disk side is tapered toward the disk surface. The distal end portion 66a of the main pole 66 has, for example, a rectangular cross-section. The distal end surface of the main pole 66 is exposed in the ABS 43 of the slider 42. In the present embodiment, width W1 of the distal end portion 66a of the main pole 66 is substantially equal to the track width of the magnetic disk 12.

The trailing-shield pole 68 is substantially L-shaped and its distal end portion 68a has an elongated rectangular shape. The distal end surface of the trailing-shield pole 68 is exposed in the ABS 43 of the slider 42. A leading end surface 68b of the distal end portion 68a extends transversely relative to the track of the magnetic disk 12. The leading end surface 68b is opposed substantially parallel to a trailing end surface 72a of the distal end portion 66a of the main pole 66 with recording gap WG therebetween.

The recording head 56 comprises a high-frequency oscillator, e.g., the spin oscillator 74, arranged in recording gap WG between the distal end portion 66a of the main pole 66 and the trailing-shield pole 68. The spin oscillator 74 is interposed between the trailing end surface 72a of the distal end portion 66a of the main pole 66 and the leading end surface 68b of the trailing-shield pole 68 and arranged parallel to these end surfaces. The spin oscillator 74 has its distal end exposed in the ABS 43 and is disposed flush with the distal end surface of the main pole 66 with respect to the surface of the magnetic disk 12.

As shown in FIG. 3, the power supply 70b is connected to the main and trailing-shield poles 66 and 68, and a current circuit is formed such that current from the power supply can be passed in series through the main and trailing-shield poles 66 and 68. The trailing-shield pole 68 comprises a junction 65 located near the upper part of the main pole 66 in a position off recording gap WG, that is, the ABS 43 of the slider. The junction 65 is connected to the main pole 66 through a back gap portion 67, which consists mainly of an insulator such as SiO₂. This insulator electrically insulates the main and trailing-shield poles 66 and 68 from each other. Thus, by forming the back gap portion 67 based on the insulator, current from the power supply 70b can be efficiently applied to the spin oscillator 74 through the main and trailing-shield poles 66 and 68 that serve also as electrodes of the oscillator 74. Al₂O₃ may be used in place of SiO₂ as the insulator of the back gap portion 67.

The back gap portion 67 may also be formed using a semiconductor, such as silicon or germanium. The main and trailing-shield poles 66 and 68, along with an electrical conductor, may be electrically connected to a part of the back gap portion 67 of the insulator or semiconductor.

Under the control of the control circuit board 25, the spin oscillator 74 is supplied with direct current along its film thickness as voltage from the power supply 70 is applied to the poles 66 and 68. By this current supply, the magnetization of the oscillator layer of the spin oscillator 74 can be rotated to produce a high-frequency magnetic field. In this way, the high-frequency magnetic field is applied to the recording layer of the magnetic disk 12. Thus, the main and trailing-shield poles 66 and 68 serve as electrodes for perpendicular energization of the spin oscillator 74.

As shown in FIGS. 3 to 6, the spin oscillator 74 comprises a spin vibration layer 74b and interlayers 74a and 74c of a nonmagnetic good conductor. The spin vibration layer 74b generates magnetization to produce a high-frequency magnetic field at a frequency of 1 GHz or more. The interlayers 74a and 74c are arranged individually between the main pole 66 and spin vibration layer 74b and between the trailing-shield pole 68 and spin vibration layer 74b and serve to electrically connect the spin vibration layer 74b to the main and trailing-shield poles.

The spin vibration layer 74b is formed of, for example, a 13-nm-thick magnetic film of Fe—Co—Al; the interlayer 74a, a 2-nm-thick copper film 74c; and interlayer 74c, a laminated film of copper and ruthenium. The interlayer 74a, spin vibration layer 74b, and interlayer 74c are sequentially laminated from the side of the main pole 66 to the side of the trailing-shield pole 68. The lower surface of the spin oscillator 74 is flush with the ABS of the slider. Preferably, width W1 of the trailing end surface 72a of the distal end portion 66a of the main pole 66 is greater than width W2 of the spin oscillator 74 along the track.

The material for the spin vibration layer 74b,besides Fe—Co—Al, may be a soft magnetic layer having relatively high saturated magnetic flux density and magnetic anisotropy in the film in-plane direction, such as Co—Fe, Co—Ni—Fe, Ni—Fe, Co—Zr—Nb, Fe—N, Fe—Si, Fe—Al—Si, Fe—Co—Al, Fe—Co—Si, or Co—Fe—B, or a Co—Cr-based magnetic alloy film whose magnetization is oriented in the film in-plane direction, such as Co—Ir. Further, a laminated film consisting of the above-described plurality of materials stacked in layers may be used for the spin vibration layer 74b to adjust saturation magnetization and an anisotropic magnetic field. Furthermore, for example, a 5- to 20-nm-thick film of a high-brass soft magnetic material (Fe—Co/Ni—Fe laminated film) can be used for the spin vibration layer 74b.

A nonmagnetic material with high spin permeability, such as copper, gold, or silver, can be used for the interlayers 74a and 74c. The film thickness of the interlayers 74a and 74c can be adjusted to one-atomic-layer thickness to about 3 nm.

Preferably, the element size (size of a cross-section taken along a plane perpendicular to the direction of lamination) of the spin oscillator 74 is adjusted to 10 to 100 nm square. The element shape is not limited to the cuboid shape and may alternatively be columnar or hexagonally prismatic. The element size is not limited to those values, and the materials and sizes of the spin vibration layer 74b and interlayers 74a and 74c are optionally selectable.

In the distal end portion 66a of the main pole 66, as shown in FIGS. 3 to 6, the magnetic seed layer 80 is formed on the trailing end surface 72a, and moreover, the highly oriented magnetic layer 82 of a soft magnetic material is superposed on the seed layer 80. The interlayer 74a of the spin oscillator 74 contacts the highly oriented magnetic layer 82. The respective lower ends of the magnetic seed layer 80 and magnetic layer 82 are flush with the ABS 43 of the slider.

The magnetic seed layer 80 is formed using an amorphous material, such as Co—Zr—Nb, Fe—Co—B, etc. Preferably, the film thickness of the highly oriented magnetic layer 82 should be made less than the thickness of the main pole 66, in order to secure the intensity of a magnetic field produced by the main pole 66 and improve the oscillatory properties of the spin vibration layer 74b.

The magnetic seed layer 80 and highly oriented magnetic layer 82 are formed covering the entire transverse area of the distal end portion 66a of the main pole 66, and their width W1 is greater than width W2 of the spin oscillator 74. Height T of the magnetic seed layer 80 and highly oriented magnetic layer 82 perpendicular to the ABS 43 of the slider is greater than (e.g., 1.5 times as great as) height T2 of the oscillator 74. If T1 is less than T2, the density of current through the spin vibration layer 74b is lower than that of current through the magnetic layer 82. Accordingly, the effective spin polarization is reduced, so that the oscillatory properties become worse. At the same time, moreover, the less T1 is, the greater the influence of a spin torque reaction the magnetic layer 82 receives from the spin vibration layer 74b is. Consequently, the oscillatory properties are degraded.

High orientation of the highly oriented magnetic layer 82 implies that the crystal orientation of the layer 82 has a fixed crystal azimuth perpendicular to the film surface. The magnetic layer 82 may be either multi- or mono-crystalline. In the case of a multi-crystalline layer, the respective azimuths of crystal grains need not be uniform in the direction parallel to the film surface and should only be uniform perpendicular to the film surface. Preferably, the dispersion in crystal azimuth perpendicular to the film surface of each crystal grain is within 5°. If the dispersion exceeds 5°, the respective directions of currents through the crystal grains and crystal azimuths vary according to the crystal grains. Therefore, the spin polarization is subject to variation, so that the oscillatory properties of the spin vibration layer become worse as a whole. More preferably, the highly oriented magnetic layer 82 should be formed into a face-centered cubic (FCC) structure such that crystals are oriented in a

direction relative to the trailing end surface 72a of the main pole 66, in order to improve the spin polarization. If the spin polarization is improved, the oscillatory properties of the spin vibration layer 74b are improved, so that the assist effect is enhanced. Thereupon, the recording magnetization of the recording medium is liable to be reversed, and the overwrite property is improved. Fe—Co—Al o r the like can be used for the material of a layer for FCC [111] orientation. Further, the same effect can be obtained if Fe—Co—Cu or the like is used to form the highly oriented magnetic layer 82 into a body-centered cubic (BCC) structure such that crystals are oriented in a [110] direction relative to the trailing end surface 72a of the main pole 66. Furthermore, the same effect can be obtained if at least two or more elements selected from a group including iron, cobalt, nickel, copper, aluminum, and silicon are combined to form the highly oriented magnetic layer into an FCC or BCC structure or an amorphous structure.

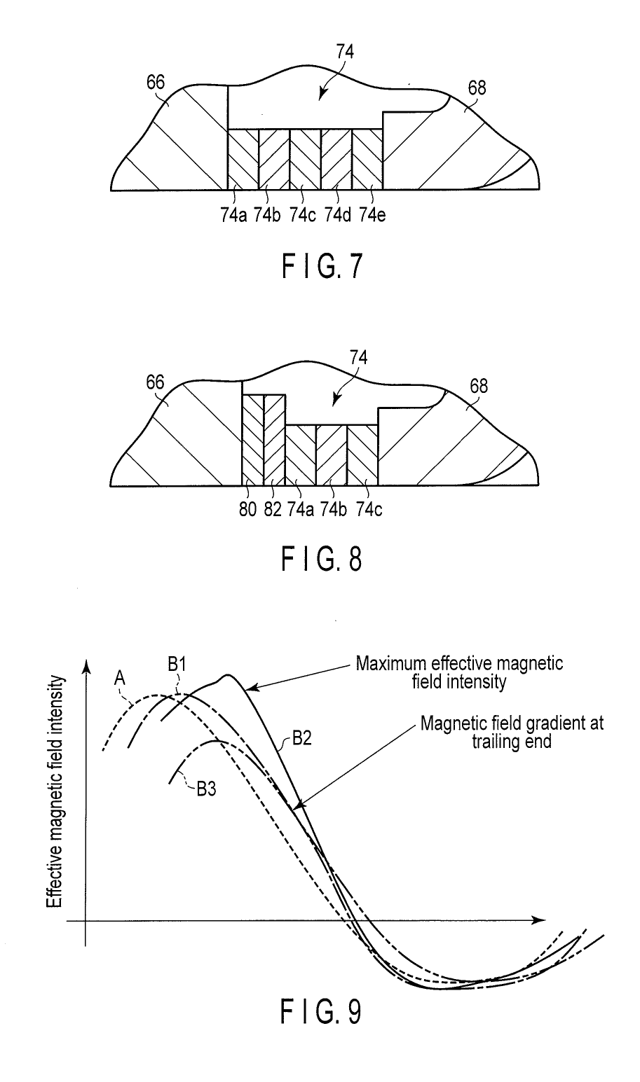

Preferably, the saturated magnetic flux density of the highly oriented magnetic layer 82 is less than that of the main pole 66 such that the difference between them is within a range of 0.5 to 1.5 T. FIG. 7 is an enlarged sectional view showing an end portion of a high-frequency assist recording head according to a comparative example on the side of a magnetic disk. FIG. 8 is an enlarged sectional view showing the disk-side end portion of the recording head according to the present embodiment. FIG. 9 is a diagram comparatively showing magnetic field intensity distributions corresponding to the saturated magnetic flux densities of the respective highly oriented magnetic layers of the recording heads according to the comparative example and the embodiment.

As shown in FIG. 7, a recording head A according to the comparative example comprises neither a magnetic seed layer nor a highly oriented magnetic layer, while a spin oscillator 74 comprises an interlayer 74a, spin vibration layer 74b, interlayer 74c, spin injection layer 74d, and interlayer 74e laminated to one another. In the recording head of the present embodiment shown in FIG. 8, a highly oriented magnetic layer 82 is assumed to be formed using a material (B1) with the saturated magnetic flux density of 0.5 T, material (B2) with the saturated magnetic flux density of 1.5 T, or material (B3) with the saturated magnetic flux density of 22.2 T.

In recording head A of the comparative example, as shown in FIG. 9, the magnetic field gradient at the trailing end portion of a main pole is gentle, although the magnetic field intensity is high. Although the overwrite property for data recording on the recording medium is satisfactory, in this case, the recording density cannot be increased due to poor on-track recording quality (signal-to-noise ratio).

In recording head B1 of the present embodiment, in contrast, the magnetic field gradient at the trailing end portion of the main pole is so great that the on-track recording quality is improved. For recording head B2 of the present embodiment, moreover, it is indicated that both the effective magnetic field intensity and the magnetic field gradient are further improved. In recording head B3 of the present embodiment, the field gradient is on the same level as that of recording head B2. It is indicated, however, that the spin oscillation is insufficient for an assist effect and the effective magnetic field intensity is reduced.

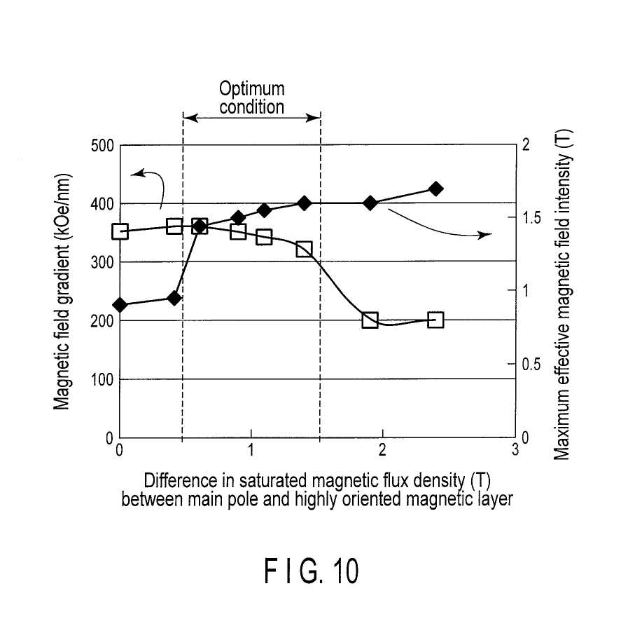

Thus, recording heads B1 and B2 according to the present embodiment exhibit increased magnetic field intensity and recording resolution due to the good assist effect of the spin oscillator 74, and hence, improved recording quality. FIG. 10 shows relationships between the difference in saturated magnetic flux density, magnetic field gradient, and maximum effective magnetic field intensity. If the difference between the respective saturated magnetic flux densities of the main pole 66 and highly oriented magnetic layer 82 is small, e.g., less than 0.5 T, the field gradient increases due to the effect of reduction of recording gap WG, as shown in FIG. 10. If the difference between the saturated magnetic flux densities of the main pole 66 and magnetic layer 82 is great, e.g., more than 1.5 T, the field gradient becomes gentle just below the magnetic layer 82, and the recording resolution is not improved. If the difference between the saturated magnetic flux densities of the main pole 66 and magnetic layer 82 increases, moreover, the oscillatory properties of the spin oscillator are improved, so that the effective magnetic field intensity is suddenly increased. Thus, it is evident that the oscillatory properties of the spin oscillator and the recording resolution can be improved by adjusting the difference in saturated magnetic flux density between the main pole 66 and highly oriented magnetic layer 82 to the range of 0.5 to 1.5 T.

In writing data, according to the HDD constructed in this manner, direct current is passed through the spin-torque oscillator 74 to produce a high-frequency magnetic field, which is applied to the perpendicular magnetic recording layer 22 of the magnetic disk 12. Further, the main pole 66 is excited by the recording coil 71. Data is recorded with a desired track width in such a manner that a perpendicular recording magnetic field is applied to the recording layer 22 of the magnetic disk 12 just below the main pole. Magnetic recording with high coercivity and high magnetically anisotropic energy can be achieved by superposing the high-frequency magnetic field on the recording magnetic field. With the recording head 56 constructed in the above-described manner, the recording resolution is improved, and the oscillatory properties of the spin oscillator 74 are satisfactory. Since the effective magnetic field intensity of the recording head 56 and the magnetic field gradient are increased, moreover, the signal-to-noise ratio of signals recorded on the magnetic disk is improved, so that the recording density can be improved.

Thus, there may be obtained a magnetic head with improved recording resolution and density and stable recording properties, a head gimbal assembly provided with the same, and a disk drive.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording head comprising:
a main pole configured to apply a magnetic field perpendicular to a recording medium;
a trailing-shield pole;
a recording gap between the main pole and the trailing-shield pole;
a high-frequency oscillator between the main pole and the trailing-shield pole in the recording gap, configured to produce a high-frequency magnetic field;
a magnetic seed layer between the main pole and the high-frequency oscillator and in contact with the main pole; and
a highly-oriented magnetic layer of a soft magnetic material on the magnetic seed layer between the main pole and the high-frequency oscillator and contacting the high-frequency oscillator.

2. The magnetic recording head of claim 1, wherein the highly-oriented magnetic layer comprises two or more elements selected from the group consisting of iron, cobalt, nickel, copper, aluminum, and silicon and has a face-centered cubic structure such that crystals are oriented in a [111] direction relative to a trailing-end surface of the main pole.

3. The magnetic recording head of claim 2, wherein the difference in saturated magnetic flux density between the main pole and the highly-oriented magnetic layer is between about 0.5T and about 1.5 T.

4. The magnetic recording head of claim 2, wherein the high-frequency oscillator comprises a spin vibration layer between the main pole and the trailing-shield pole in the recording gap, a first interlayer comprising a nonmagnetic conductor between the spin vibration layer and the highly-oriented magnetic layer and configured to electrically connect the main pole and the spin vibration layer, and a second interlayer comprising a nonmagnetic conductor between the spin vibration layer and the trailing-shield pole and configured to electrically connect the spin vibration layer and the trailing-shield pole.

5. The magnetic recording head of claim 2, further comprising a recording coil around a magnetic core comprising the main pole and the trailing-shield pole and a power supply configured to pass direct current between the trailing-shield pole and the main pole, wherein the trailing-shield pole comprises a junction in a position off the recording gap and connected to the main pole through an insulator or a semiconductor.

6. The magnetic recording head of claim 1, wherein the highly-oriented magnetic layer comprises two or more elements selected from the group consisting of iron, cobalt, nickel, copper, aluminum, and silicon and has a body-centered cubic structure such that crystals are oriented in a [110] direction relative to a trailing-end surface of the main pole.

7. The magnetic recording head of claim 6, wherein the difference in saturated magnetic flux density between the main pole and the highly-oriented magnetic layer is between about 0.5 T and about 1.5 T.

8. The magnetic recording head of claim 6, wherein the high-frequency oscillator comprises a spin vibration layer between the main pole and the trailing-shield pole in the recording gap, a first interlayer comprising a nonmagnetic conductor between the spin vibration layer and the highly-oriented magnetic layer and configured to electrically connect the main pole and the spin vibration layer, and a second interlayer comprising a nonmagnetic conductor between the spin vibration layer and the trailing-shield pole and configured to electrically connect the spin vibration layer and the trailing-shield pole.

9. The magnetic recording head of claim 6, further comprising a recording coil around a magnetic core comprising the main pole and the trailing-shield pole and a power supply configured to pass direct current between the trailing-shield pole and the main pole, wherein the trailing-shield pole comprises a junction in a position off the recording gap and connected to the main pole through an insulator or a semiconductor.

10. The magnetic recording head of claim 1, wherein the highly-oriented magnetic layer comprises two or more elements selected from the group consisting of iron, cobalt, nickel, copper, aluminum, and silicon and has an amorphous structure.

11. The magnetic recording head of claim 10, wherein the difference in saturated magnetic flux density between the main pole and the highly oriented magnetic layer is between about 0.5 T and about 1.5 T.

12. The magnetic recording head of claim 10, wherein the high-frequency oscillator comprises a spin vibration layer between the main pole and the trailing-shield pole in the recording gap, a first interlayer comprising a nonmagnetic conductor between the spin vibration layer and the highly-oriented magnetic layer and configured to electrically connect the main pole and the spin vibration layer, and a second interlayer comprising a nonmagnetic conductor between the spin vibration layer and the trailing-shield pole and configured to electrically connect the spin vibration layer and the trailing-shield pole.

13. The magnetic recording head of claim 10, further comprising a recording coil around a magnetic core comprising the main pole and the trailing-shield pole and a power supply configured to pass direct current between the trailing-shield pole and the main pole, wherein the trailing-shield pole comprises a junction in a position off the recording gap and connected to the main pole through an insulator or a semiconductor.

14. A head gimbal assembly comprising:
a slider;
the magnetic recording head of claim 1 on the slider; and
a suspension configured to support the slider.

15. A disk drive comprising:
a disk recording medium comprising a recording layer having a magnetic anisotropy perpendicular to a surface of the medium;
a drive unit configured to support and rotate the recording medium; and
the magnetic head of claim 1 configured to perform data processing on the recording medium.
